(19) United States
(12) Patent Application Publication
(10) Pub. No.: US 2025/0214602 A1
(43) Pub. Date: Jul. 3, 2025

(54) ASSISTANCE DEVICE, ASSISTANCE METHOD, AND COMPUTER PROGRAM PRODUCT

(71) Applicant: Panasonic Automotive Systems Co., Ltd., Kanagawa (JP)

(72) Inventor: Mikio YAGI, Osaka Fu (JP)

(73) Assignee: Panasonic Automotive Systems Co., Ltd., Kanagawa (JP)

(21) Appl. No.: 18/985,809

(22) Filed: Dec. 18, 2024

(30) Foreign Application Priority Data
Dec. 28, 2023 (JP) 2023-223159

(51) Int. Cl. B60W 50/14; B60W 40/08

(52) U.S. Cl. CPC B60W 50/14; B60W 40/08; B60W 2540/22

(57) ABSTRACT

An assistance device according to the present disclosure includes a memory in which a program is stored and a processor coupled to the memory and configured to perform processing by executing the program. The processing includes: specifying expected increase amounts of a Brain Healthcare Quotient (BHQ) of a driver of a vehicle for a plurality of suggestion items; selecting one suggestion item from among the plurality of suggestion items in accordance with the specified expected increase amount; and suggesting the one or more suggestion items to the driver.

### CROSS-REFERENCE TO RELATED APPLICATIONS

This application is based upon and claims the benefit of priority from Japanese Patent Application No. 2023-223159, filed Dec. 28, 2023, the entire contents of which are incorporated herein by reference.

### FIELD

Embodiments described herein relate generally to an assistance device, an assistance method, and a computer program product.

### BACKGROUND

An assistance device mounted on a vehicle can assist driving of the vehicle by a driver by suggesting predetermined information to the driver of the vehicle. The related technologies are described, for example, in: Japanese Patent Application Laid-open No. 2009-101714, and Japanese Patent Application Laid-open No. 2019-124975.

For example, if a suggestion for improving a Brain Healthcare Quotient (BHQ) of the driver can be given to the driver, it is expected that a state of brain health can be maintained/improved by driving.

The present disclosure provides an assistance device, an assistance method, and a computer program product, which can maintain/improve a state of brain health by driving.

### SUMMARY

An assistance device according to an embodiment of the present disclosure includes a memory in which a program is stored and a processor coupled to the memory and configured to perform processing by executing the program. The processing includes: specifying expected increase amounts of a Brain Healthcare Quotient (BHQ) of a driver of a vehicle for a plurality of suggestion items; selecting one or more suggestion items from among the plurality of suggestion items in accordance with the specified expected increase amounts; and suggesting the one or more suggestion items to the driver.

### BRIEF DESCRIPTION OF THE DRAWINGS

FIG. 1 is a diagram illustrating a vehicle on which an assistance device according to an embodiment is mounted;

FIG. 2 is a diagram illustrating a hardware configuration of the assistance device according to the embodiment;

FIG. 3 is a diagram illustrating a functional configuration of the assistance device according to the embodiment;

FIG. 4 is a diagram illustrating a data structure of object information in the embodiment;

FIGS. 5A, 5B, and 5C are diagrams illustrating data structures of characteristic information in the embodiment;

FIG. 6 is a diagram illustrating a data structure of suggestion item information in the embodiment;

FIG. 7 is a flowchart illustrating operation of the assistance device according to the embodiment;

FIG. 8 is a flowchart illustrating operation of the assistance device according to a first modification of the embodiment;

FIG. 9 is a flowchart illustrating operation of the assistance device according to a second modification of the embodiment;

FIG. 10 is a flowchart illustrating operation of the assistance device according to a third modification of the embodiment;

FIG. 11 is a flowchart illustrating operation of the assistance device according to a fourth modification of the embodiment; and

FIG. 12 is a flowchart illustrating operation of the assistance device according to the fourth modification of the embodiment.

### DETAILED DESCRIPTION

The following describes an embodiment of an assistance device according to the present disclosure with reference to the accompanying drawings.

### Embodiment

The assistance device according to the embodiment is mounted on a vehicle, and can assist driving of the vehicle by a driver by suggesting predetermined information to the driver of the vehicle. The assistance device is devised for maintaining/improving a state of brain health by driving.

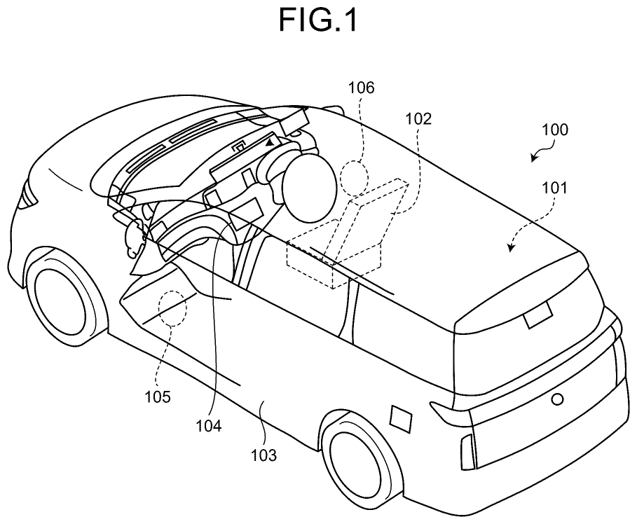

For example, as illustrated in FIG. 1, an assistance device 1 may be mounted on a vehicle 100. FIG. 1 is a diagram illustrating the vehicle 100 on which the assistance device 1 is mounted.

The assistance device 1 is mounted on the vehicle 100, and may assist driving by a driver (not illustrated) boarding in a cabin 101. The cabin 101 is a space surrounded by a vehicle body 103 having a substantially box shape. In the cabin 101, a display 104 is disposed at a position that can be visually recognized by the driver. In the cabin 101, speakers 105 and 106 are disposed in the vicinity of the driver.

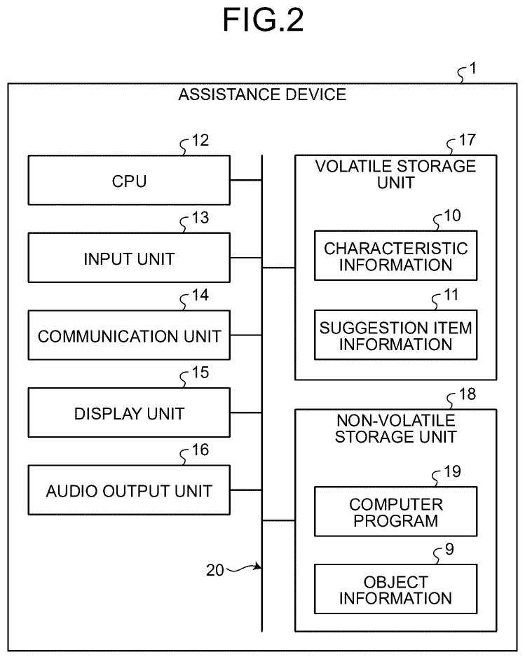

The assistance device 1 may be configured as illustrated in FIG. 2 as hardware. FIG. 2 illustrates a hardware configuration of the assistance device 1.

The assistance device 1 includes a CPU 12, an input unit 13, a communication unit 14, a display unit 15, an audio output unit 16, a volatile storage unit 17, a non-volatile storage unit 18, and a bus 20. The CPU 12, the input unit 13, the communication unit 14, the display unit 15, the audio output unit 16, the volatile storage unit 17, and the non-volatile storage unit 18 are connected to each other via the bus 20 in a communicable manner.

The CPU 12 integrally controls parts of the assistance device 1.

The input unit 13 performs user interface operation for the driver. The input unit 13 can receive instructions from the driver via a button, a touch panel, and the like. When receiving an instruction from the driver, the input unit 13 supplies the instruction to the CPU 12.

The communication unit 14 can receive predetermined information from the outside via a wireless communication line and/or a wired communication line.

The display unit 15 includes the display 104. The display unit 15 can display predetermined information on the display 104 under control by the CPU 12.

The audio output unit 16 includes the speakers 105 and 106. The audio output unit 16 can output predetermined information by audio from the speakers 105 and 106 under control by the CPU 12.

The volatile storage unit 17 temporarily stores information. The volatile storage unit 17 may also be used as a working area for the CPU 12.

The non-volatile storage unit 18 stores information in a non-volatile manner. The non-volatile storage unit 18 may store a computer program 19 for performing an assistance method by the assistance device 1.

The display unit 15 may display driving assistance information on the display 104. The audio output unit 16 may output the driving assistance information by audio from the speakers 105 and 106 in place of display of the driving assistance information by the display unit 15, or in addition to display of the driving assistance information by the display unit 15.

The driving assistance information includes, for example, vehicle speed information, navigation information, pedestrian information, preceding vehicle information, lane departure warning, and a vehicle condition. The navigation information includes right-turn guidance, left-turn guidance, forward movement guidance, stop guidance, vehicle-stop guidance, parking guidance, right-lane change guidance, left-lane change guidance, and the like.

Accordingly, the assistance device 1 can perform driving assistance for the driver seated on a driver's seat 102.

It is examined that driving assistance for the driver may be performed from a viewpoint of another aspect. Values have started to change such that a desire for materials and money has been changed to a desire for spiritual wealth. The change in values is said to be a change from materials to things, a change from a degree of affluence to a degree of happiness, and a change from life expectancy to healthy life expectancy in some cases. In such a situation, improvement in a Brain Healthcare Quotient (BHQ) is desired. It is expected that a state of brain health can be maintained/improved by driving if a suggestion for improving the BHQ of the driver of the vehicle 100 can be given to the driver.

The BHQ is based on a brain image of Magnetic Resonance Imaging (MRI) and the like that have been used mainly in a medical field. The BHQ is an index of a degree of brain health obtained by analyzing an image in a brain healthcare region. The BHQ is a concept for aiming at establishment of brain information that can be easily used by any person, and aiming at achieving society in which each individual can enjoy spiritual wealth.

The BHQ includes Grey-Matter Brain Healthcare Quotient (GM-BHQ) and Fractional Anisotropy Brain Healthcare Quotient (FA-BHQ). The GM-BHQ is an average value of a gray matter mass data group included in a brain, and is a single scalar quantity. The FA-BHQ is an average value of a nerve fiber anisotropy data group included in a brain, and is a single scalar quantity.

In the present specification, the BHQ may be the GM-BHQ, or the FA-BHQ. The BHQ may also be an average value of the GM-BHQ and the FA-BHQ, a larger value of the GM-BHQ and the FA-BHQ, or a smaller value of the GM-BHQ and the FA-BHQ.

The assistance device 1 acquires a plurality of suggestion items, specifies an expected increase amount of the BHQ corresponding to the suggestion items, and selects one or more suggestion items in accordance with the expected increase amount to be suggested to the driver. Due to this, the assistance device 1 can assist driving of the vehicle by the driver regarding spiritual wealth.

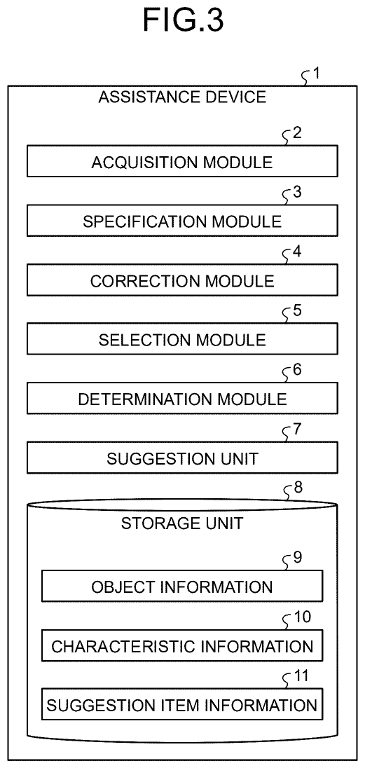

To make such a suggestion, the assistance device 1 may be functionally configured as illustrated in FIG. 3. FIG. 3 is a diagram illustrating a functional configuration of the assistance device 1.

The assistance device 1 includes an acquisition module 2, a specification module 3, a correction module 4, a selection module 5, a determination module 6, a suggestion unit 7, and a storage unit 8. In the assistance device 1, part of the storage unit 8 may be implemented by the volatile storage unit 17, and the other part of the storage unit 8 may be implemented by the non-volatile storage unit 18. The suggestion unit 7 may be implemented by the display unit 15 and/or the audio output unit 16. In the assistance device 1, parts other than the suggestion unit 7 and the storage unit 8 may be implemented as hardware (for example, as a circuit), may be implemented as software, or part of them may be implemented as hardware and the rest of them may be implemented as software. In a case in which the parts other than the suggestion unit 7 and the storage unit 8 are implemented as software, the CPU 12 (refer to FIG. 2) may execute the computer program 19, and may functionally construct, on the volatile storage unit 17, the parts other than the suggestion unit 7 and the storage unit 8 illustrated in FIG. 3 in a collective manner at the time of compiling, or in a successive manner corresponding to progress of processing.

The acquisition module 2 acquires a plurality of suggestion items. Each of the suggestion items may include an object, may include a characteristic, or may include a combination of the object and the characteristic. The object relates to content to be suggested to the driver. The object includes at least one of a destination, a path, a driving assistance function, a driving manner, and cabin space control. The path may include a change of a roadside store, uniqueness of a road, difficulty of a road (for example, a road with close right/left turns, a narrow road, a road on which there are many pedestrians and bicycles), and the like. The driving assistance function may include causing the display 104 to display unusual driving assistance information, slow moving without braking, and the like. The driving manner may include performing manual cruise control like a game, driving with left turns only, passing through as many convenience stores as possible, and the like. The cabin space control may include activating an automatic air conditioner, activating internal air circulation, randomly reproducing music, and the like. The characteristic relates to an additional element of the content to be suggested to the driver. The characteristic includes at least one of novelty, enjoyment, and momentum.

For example, information as a source of the suggestion items may be stored in the storage unit 8, and the acquisition module 2 may equivalently acquire the suggestion items by acquiring the information as a source of the suggestion items.

The storage unit 8 may store object information 9 as information as a source of the suggestion items. The object information 9 may be stored in the non-volatile storage unit 18 (refer to FIG. 2). The object information 9 may be stored in the non-volatile storage unit 18 at the time when the assistance device 1 is shipped. Alternatively, the object information 9 may be dynamically acquired by the communication unit 14 from a cloud server via a communication line after the assistance device 1 is shipped, and stored in the non-volatile storage unit 18. Such dynamic acquisition may be performed every time, once in multiple times, or once at a certain period of time.

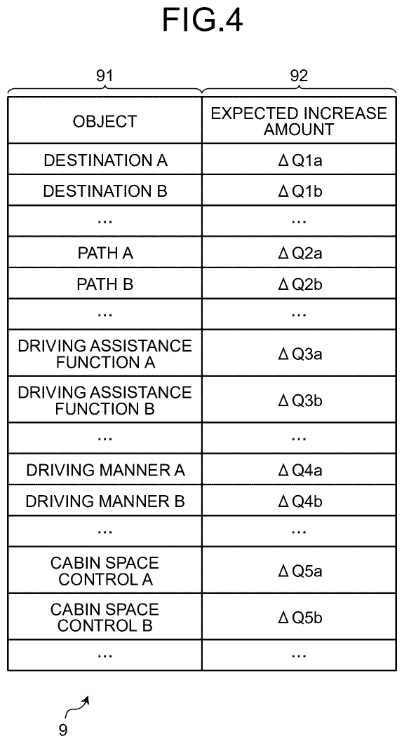

As illustrated in FIG. 4, the object information 9 may be information in which the object and the expected increase amount are associated with each other for each of candidates for a plurality of objects. FIG. 4 is a diagram illustrating a data structure of the object information 9.

The object information 9 includes an object column 91 and an expected increase amount column 92. In the object column 91, content of the object or information for identifying the object is recorded. In the object column 91, a destination A, a destination B, . . . , a path A, a path B, . . . , a driving assistance function A, a driving assistance function B, . . . , a driving manner A, a driving manner B, . . . , cabin space control A, cabin space control B, . . . may be recorded. “Destination A, destination B, . . . ” represent specific candidates for the object of “destination”. “Path A, path B, . . . ” represent specific candidates for the object of “path”. “Driving assistance function A, driving assistance function B, . . . ” represent specific candidates for the object of “driving assistance function”. “Driving manner A, driving manner B, . . . ” represent specific candidates for the object of “driving manner”. “Cabin space control A, cabin space control B, . . . ” represent specific candidates for the object of “cabin space control”. In the expected increase amount column 92, the expected increase amount is recorded. In the expected increase amount column 92, ΔQ1a, ΔQ1b, . . . , ΔQ2a, ΔQ2b, . . . , ΔQ3a, ΔQ3b, . . . , ΔQ4a, ΔQ4b, . . . , ΔQ5a, ΔQ5b, . . . may be recorded. The expected increase amount corresponding to the candidate for each object may be experimentally acquired in advance, and recorded in the expected increase amount column 92. By referring to the object information 9, the expected increase amount corresponding to the candidate for each object can be specified.

In a case of FIG. 4, the expected increase amount corresponding to the candidate of “destination A” for the object of “destination” is specified to be ΔQ1a. The expected increase amount corresponding to the candidate of “destination B” for the object of “destination” is specified to be ΔQ1b . . . . The expected increase amount corresponding to the candidate of “path A” for the object of “path” is specified to be ΔQ2a. The expected increase amount corresponding to the candidate of “path B” for the object of “path” is specified to be ΔQ2b. The expected increase amount corresponding to the candidate of “driving assistance function A” for the object of “driving assistance function” is specified to be ΔQ3a. The expected increase amount corresponding to the candidate of “driving assistance function B” for the object of “driving assistance function” is specified to be ΔQ3b . . . . The expected increase amount corresponding to the candidate of “driving manner A” for the object of “driving manner” is specified to be ΔQ4a. The expected increase amount corresponding to the candidate of “driving manner B” for the object of “driving manner” is specified to be ΔQ4b. The expected increase amount corresponding to the candidate of “cabin space control A” for the object of “cabin space control” is specified to be ΔQ5a. The expected increase amount corresponding to the candidate of “cabin space control B” for the object of “cabin space control” is specified to be ΔQ5b . . . .

For example, the acquisition module 2 illustrated in FIG. 3 accesses the storage unit 8, and reads out the object information 9 from the storage unit 8. Due to this, the acquisition module 2 acquires a plurality of suggestion items corresponding to a plurality of objects included in the object information 9. The acquisition module 2 supplies the suggestion items to the specification module 3. The acquisition module 2 may supply the object information 9 to the specification module 3 as information indicating the suggestion items.

The specification module 3 receives the suggestion items from the acquisition module 2. The specification module 3 specifies the expected increase amount of the BHQ of the driver for each of the suggestion items. The specification module 3 may specify the expected increase amount of the BHQ of the driver for each of the suggestion items in accordance with expected increase amounts included in the object information 9.

Alternatively, the object information 9 may be information from which the expected increase amount column 92 is omitted, and the specification module 3 may specify the expected increase amount of the BHQ of the driver for each of the suggestion items by calculating the expected increase amount for each of the objects included in the object information 9.

For example, the acquisition module 2 illustrated in FIG. 3 accesses the storage unit 8, and reads out the object information 9 from the storage unit 8 to be supplied to the specification module 3. The specification module 3 calculates the expected increase amount for each of a plurality of characteristics for each of the candidates for the respective objects included in the object information 9, and generates characteristic information 10 as a calculation result. The characteristic information 10 corresponding to each of the candidates for the respective objects may be stored in the volatile storage unit 17 (refer to FIG. 2), or may be stored in the non-volatile storage unit 18 (refer to FIG. 2). The characteristic information 10 corresponding to each of the candidates for the respective objects may be stored in the non-volatile storage unit 18 at the time when the assistance device 1 is shipped. Alternatively, the characteristic information 10 corresponding to each of the candidates for the respective objects may be dynamically acquired by the communication unit 14 from a cloud server via a communication line after the assistance device 1 is shipped, and may be stored in the non-volatile storage unit 18. Such dynamic acquisition may be performed every time, once in multiple times, or once at a certain period of time.

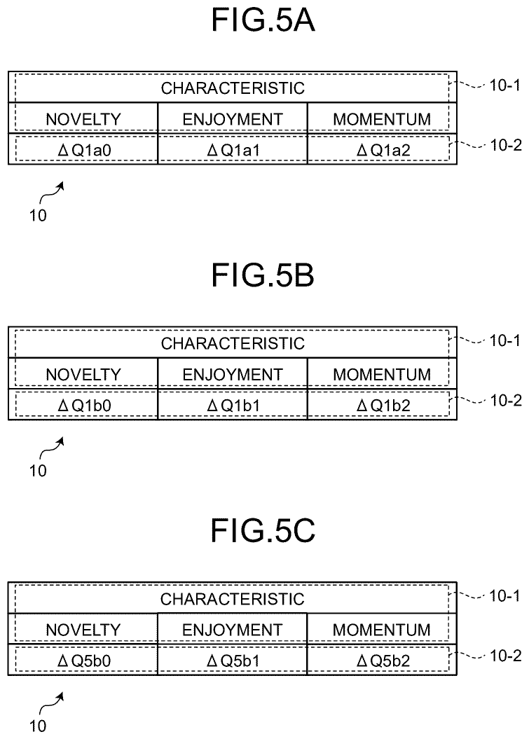

The characteristic information 10 corresponding to the candidate of “destination A” for the object may be information in which the characteristic is associated with the expected increase amount for each of the characteristics as illustrated in FIG. 5A. FIGS. 5A, 5B, and 5C are diagrams illustrating data structures of the characteristic information 10.

The characteristic information 10 includes a characteristic column 10-1 and an expected increase amount column 10-2. In the characteristic column 10-1, content of the characteristic or information for identifying the characteristic is recorded. In the characteristic column 10-1, novelty, enjoyment, and momentum may be recorded. In the expected increase amount column 10-2, the expected increase amount is recorded. In the expected increase amount column 10-2, ΔQ1a0, ΔQ1a1, and ΔQ1a2 may be recorded. By referring to the characteristic information 10, the expected increase amount corresponding to the candidate for each characteristic can be specified.

In a case of FIG. 5A, the expected increase amount corresponding to the characteristic of “novelty” for the candidate of “destination A” for the object is specified to be ΔQ1a0. The expected increase amount corresponding to the characteristic of “enjoyment” for the candidate of “destination A” for the object is specified to be ΔQ1a1. The expected increase amount corresponding to the characteristic of “momentum” for the candidate of “destination A” for the object is specified to be ΔQ1a2.

Similarly, the characteristic information 10 corresponding to the candidate of “destination B” for the object may be information in which the characteristic is associated with the expected increase amount for each of the characteristics as illustrated in FIG. 5B. In a case of FIG. 5B, the expected increase amount corresponding to the characteristic of “novelty” for the candidate of “destination B” for the object is specified to be ΔQ1b0. The expected increase amount corresponding to the characteristic of “enjoyment” for the candidate of “destination B” for the object is specified to be ΔQ1b1. The expected increase amount corresponding to the characteristic of “momentum” for the candidate of “destination B” for the object is specified to be ΔQ1b2.

Similarly, the characteristic information 10 corresponding to the candidate of “cabin space control B” for the object may be information in which the characteristic is associated with the expected increase amount for each of the characteristics as illustrated in FIG. 5C. In a case of FIG. 5C, the expected increase amount corresponding to the characteristic of “novelty” for the candidate of “cabin space control B” for the object is specified to be ΔQ5b0. The expected increase amount corresponding to the characteristic of “enjoyment” for the candidate of “cabin space control B” for the object is specified to be ΔQ5b1. The expected increase amount corresponding to the characteristic of “momentum” for the candidate of “cabin space control B” for the object is specified to be ΔQ5b2.

For example, the specification module 3 may equivalently specify the expected increase amount of the BHQ of the driver for each of the suggestion items by generating suggestion item information 11 in accordance with the characteristic information 10 corresponding to the candidates for the respective objects. The suggestion item information 11 may be stored in the volatile storage unit 17 (refer to FIG. 2).

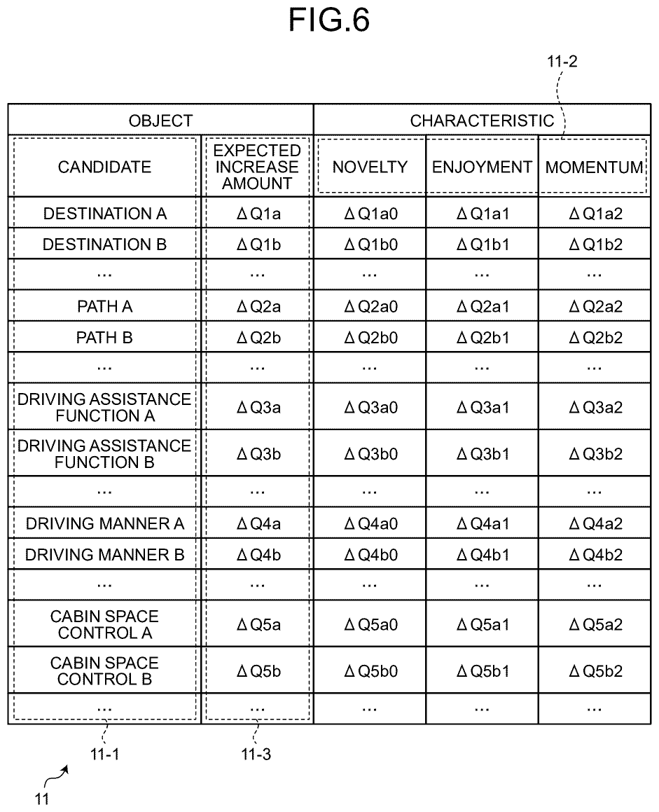

As illustrated in FIG. 6, the suggestion item information 11 may be information in which the object, the characteristic, and the expected increase amount are associated with each other for each of a plurality of combinations of the object and the characteristic. FIG. 6 is a diagram illustrating a data structure of the characteristic information 10. The combinations of the object and the characteristic correspond to the suggestion items.

The suggestion item information 11 includes an object column 11-1, a characteristic column 11-2, and an expected increase amount column 11-3. In the object column 11-1, content of the object or information for identifying the object is recorded. In the object column 11-1, a destination A, a destination B, . . . , a path A, a path B, . . . , a driving assistance function A, a driving assistance function B, . . . , a driving manner A, a driving manner B, . . . , cabin space control A, cabin space control B, . . . may be recorded. In the characteristic column 11-2, content of the characteristic or information for identifying the characteristic is recorded. In the characteristic column 11-2, novelty, enjoyment, and momentum may be recorded. In the expected increase amount column 11-3, the expected increase amount is recorded. In the expected increase amount column 11-3, ΔQ1a, ΔQ1b, . . . , ΔQ2a, ΔQ2b, . . . , ΔQ3a, ΔQ3b, . . . , ΔQ4a, ΔQ4b, . . . , ΔQ5a, ΔQ5b, . . . may be recorded. Expected increase amounts corresponding to a plurality of characteristics may be multiplied, and may be recorded in the expected increase amount column 11-3.

That is, the specification module 3 may generate the suggestion item information 11 by calculating:

$$\begin{matrix}Δ Q 1 a = Δ Q 1 a 0 \times Δ Q 1 a 1 \times Δ Q 1 a 2 ; \\ Δ Q 1 b = Δ Q 1 b 0 \times Δ Q 1 b 1 \times Δ Q 1 b 2 ;\end{matrix}$$

$$⋯$$

$$\begin{matrix}Δ Q 2 a = Δ Q 2 a 0 \times Δ Q 2 a 1 \times Δ Q 2 a 2 ; \\ Δ Q 2 b = Δ Q 2 b 0 \times Δ Q 2 b 1 \times Δ Q 2 b 2 ;\end{matrix}$$

$$⋯$$

$$\begin{matrix}Δ Q 3 a = Δ Q 3 a 0 \times Δ Q 3 a 1 \times Δ Q 3 a 2 ; \\ Δ Q 3 b = Δ Q 3 b 0 \times Δ Q 3 b 1 \times Δ Q 3 b 2 ;\end{matrix}$$

$$⋯$$

$$\begin{matrix}Δ Q 4 a = Δ Q 4 a 0 \times Δ Q 4 a 1 \times Δ Q 4 a 2 ; \\ Δ Q 4 b = Δ Q 4 b 0 \times Δ Q 4 b 1 \times Δ Q 4 b 2 ;\end{matrix}$$

$$⋯$$

$$\begin{matrix}Δ Q 5 a = Δ Q 5 a 0 \times Δ Q 5 a 1 \times Δ Q 5 a 2 ; \\ Δ Q 5 b = Δ Q 5 b 0 \times Δ Q 5 b 1 \times Δ Q 5 b 2 ;\end{matrix} and$$

$$⋯ ,$$

by using the characteristic information 10 corresponding to the candidates for the respective objects. A calculation method may be addition of the expected increase amounts corresponding to the characteristics in place of multiplication of the expected increase amounts corresponding to the characteristics.

By referring to the suggestion item information 11, the expected increase amount corresponding to a candidate for each combination of the object and the characteristic (that is, a candidate for each suggestion item) can be specified.

In a case of FIG. 6, the expected increase amount ΔQ1a is specified for a suggestion item in which the candidate of “destination A” for the object of “destination” and the characteristics of “novelty, enjoyment, and momentum” are combined.

Similarly, the expected increase amount ΔQ1b is specified for a suggestion item in which the candidate of “destination B” for the object of “destination” and the characteristics of “novelty, enjoyment, and momentum” are combined.

Similarly, the expected increase amount ΔQ5b is specified for a suggestion item in which the candidate of “cabin space control B” for the object of “cabin space control” and the characteristics of “novelty, enjoyment, and momentum” are combined.

Alternatively, the specification module 3 may regard a combination of a plurality of objects as one suggestion item, and specify the expected increase amount corresponding thereto. The specification module 3 may synthesize expected increase amounts of a plurality of objects to specify the expected increase amount corresponding to a combination of the objects. For example, the specification module 3 may synthesize an expected increase amount ΔQ6 corresponding to a combination of the candidate of “destination A” for the object of “destination” and the candidate of “path B” for the object of “path” by using ΔQ6=ΔQ1a×ΔQ2b. A synthesizing method may be addition of the expected increase amounts corresponding to the objects in place of multiplication of the expected increase amounts corresponding to the objects.

The specification module 3 illustrated in FIG. 3 supplies the expected increase amounts of the suggestion items to the selection module 5.

The selection module 5 receives the expected increase amounts of the suggestion items from the specification module 3. The selection module 5 selects one or more suggestion items from among the suggestion items in accordance with the expected increase amounts of the suggestion items. The selection module 5 may select one or more suggestion items the expected increase amount of which is equal to or larger than a threshold from among the suggestion items. The selection module 5 may select one or more suggestion items the expected increase amount of which is included in the top N (N is an integral number equal to or larger than 1) expected increase amounts from among the suggestion items. The selection module 5 supplies the one or more suggestion items to the suggestion unit 7.

The suggestion unit 7 suggests the one or more suggestion items to the driver. The suggestion unit 7 may suggest the one or more suggestion items by visual means. The suggestion unit 7 may display the one or more suggestion items on the display 104 (refer to FIG. 1) to be suggested to the driver. The suggestion unit 7 may suggest the one or more suggestion items by auditory means. The suggestion unit 7 may suggest the one or more suggestion items to the driver by outputting them from the speaker 105 (refer to FIG. 1) by audio.

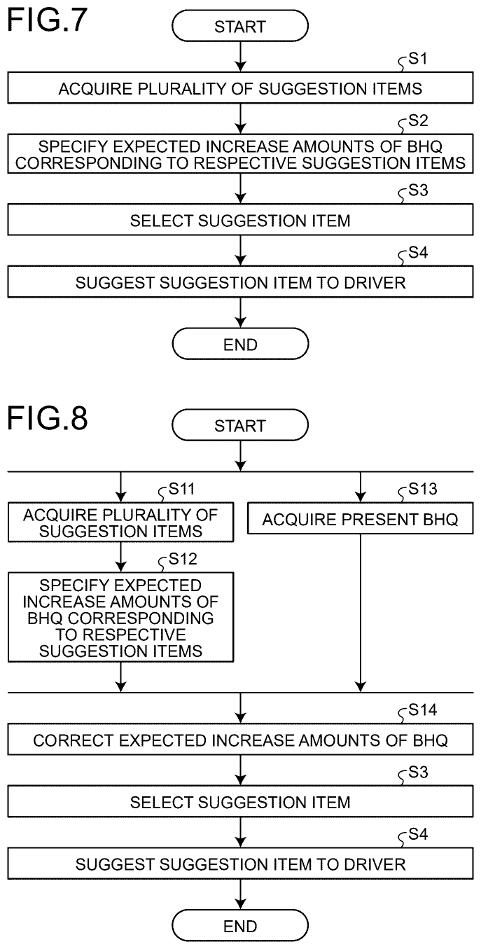

Next, the following describes operation of the assistance device 1 with reference to FIG. 7. FIG. 7 is a flowchart illustrating the operation of the assistance device 1.

The assistance device 1 starts the operation illustrated in FIG. 7 when a predetermined trigger condition is satisfied. The predetermined trigger condition may be input of an instruction to start the operation illustrated in FIG. 7 to the input unit 13. The predetermined trigger condition may be start of driving of the vehicle 100 such that an ignition of the vehicle 100 is turned on. The predetermined trigger condition may also be start-up of a power source of the vehicle 100. The predetermined trigger condition may be detection of boarding of the driver on the vehicle 100 such that a door sensor of the vehicle 100 detects a transition from a closed state to an opened state. The predetermined trigger condition may be detection of seating of the driver on the driver's seat 102 such that a pressure sensor of the driver's seat 102 detects a pressure equal to or larger than a threshold.

After starting the operation illustrated in FIG. 7, the assistance device 1 acquires a plurality of suggestion items (S1), and specifies the expected increase amounts of the BHQ corresponding to the respective suggestion items (S2). The assistance device 1 selects one or more suggestion items from among the suggestion items in accordance with the specified expected increase amounts (S3). For example, the assistance device 1 may select one or more suggestion items the expected increase amount of which is equal to or larger than the threshold from among the suggestion items, or may select one or more suggestion items the expected increase amount of which is included in the top N expected increase amounts from among the suggestion items. The assistance device 1 suggests the suggestion item selected at S3 to the driver (S4). The assistance device 1 may suggest the one or more suggestion items to the driver by displaying them on the display 104 (refer to FIG. 1), or may suggest the one or more suggestion items to the driver by outputting them by audio from the speaker 105 (refer to FIG. 1).

As described above, in the embodiment, the assistance device 1 acquires a plurality of suggestion items, specifies the expected increase amounts of the BHQ corresponding to the suggestion items, and selects one or more suggestion items corresponding to the expected increase amounts to be suggested to the driver. Due to this, the assistance device 1 can assist driving of the vehicle by the driver regarding spiritual wealth.

The display unit 15 illustrated in FIG. 2 may include a head-up display in place of the display 104 or in addition to the display 104. The head-up display is arranged in a space disposed on a lower side of a windshield. The space may be a dashboard. The space may have an opening on an upper side. The head-up display can irradiate the windshield with light through the opening from the lower side of the windshield.

Due to this, when the head-up display projects a display object onto the windshield, the display object reflected by the windshield as a display medium may be visually recognized by the driver. The head-up display projects the display object as a virtual image on a virtual screen disposed on a front side of the vehicle 100. The driver visually recognizes the display object through the windshield.

The head-up display can cause the driver to visually recognize the display object indicating the driving assistance information. The driving assistance information includes, for example, vehicle speed information, navigation information, pedestrian information, preceding vehicle information, lane departure warning, and a vehicle condition. The navigation information includes right-turn guidance, left-turn guidance, forward movement guidance, stop guidance, vehicle-stop guidance, parking guidance, right-lane change guidance, left-lane change guidance, and the like.

Alternatively, the assistance device 1 may correct the expected increase amount while considering a present BHQ of the driver.

The assistance device 1 illustrated in FIG. 3 may further include the correction module 4. The acquisition module 2 acquires the present BHQ of the driver. The correction module 4 receives the expected increase amounts of the suggestion items from the specification module 3, and receives the present BHQ of the driver from the acquisition module 2. The correction module 4 corrects the expected increase amounts of the suggestion items in accordance with the present BHQ. The correction module 4 supplies the corrected expected increase amounts to the selection module 5. Due to this, the selection module 5 can select one or more suggestion items from among the suggestion items in accordance with the expected increase amounts that are corrected while considering the present BHQ.

The assistance device 1 may operate as illustrated in FIG. 8. FIG. 8 is a flowchart illustrating the operation of the assistance device 1 according to a first modification of the embodiment.

The assistance device 1 performs processing at S11 to S12 and processing at S13 in parallel.

In the processing at S11 to S12, the assistance device 1 acquires a plurality of suggestion items (S11), and specifies the expected increase amounts of the BHQ corresponding to the respective suggestion items (S12).

In the processing at S13, the assistance device 1 acquires the present BHQ of the driver. The assistance device 1 may acquire the present BHQ of the driver by measuring the BHQ of the driver. The assistance device 1 may approximately measure the BHQ of the driver by imaging a face image of the driver and analyzing the face image. Alternatively, the assistance device 1 may issue a predetermined questionnaire to the driver. The assistance device 1 may display predetermined question information on the display 104, receive answer information from the driver by the input unit 13, and estimate the BHQ of the driver in accordance with the received answer information to acquire the present BHQ of the driver. Alternatively, the assistance device 1 may acquire a measurement result of the BHQ of the driver from the outside. The assistance device 1 may acquire the present BHQ of the driver by making an inquiry to a medical institution through a communication line via the communication unit 14, and receiving, through the communication line, information about the BHQ of the driver measured by MRI and the like in the medical institution in the past.

When the processing at S11 to S12 and the processing at S13 are both completed, the assistance device 1 corrects the expected increase amounts specified at S12 in accordance with the BHQ of the driver acquired at S13 (S14). For example, the expected increase amounts included in the object information 9 illustrated in FIG. 4 and the expected increase amounts included in the characteristic information 10 illustrated in FIGS. 5A, 5B, and 5C are experimentally acquired in advance for a standard BHQ. The assistance device 1 may correct the expected increase amounts specified at S12 in accordance with a difference of the present BHQ of the driver from the standard BHQ. The assistance device 1 may correct the expected increase amounts specified at S12 by adding the difference to the expected increase amount.

Thereafter, processing at S3 and S4 in FIG. 7 is performed similarly to the embodiment.

With such an operation, the assistance device 1 can assist driving of the vehicle by the driver regarding spiritual wealth.

Alternatively, the assistance device 1 may use a decrease amount of the BHQ of the driver as a trigger for suggestion.

The assistance device 1 illustrated in FIG. 3 may further includes the determination module 6. The acquisition module 2 acquires the present BHQ of the driver. The determination module 6 holds a previous BHQ of the driver. The determination module 6 receives the present BHQ of the driver from the acquisition module 2, and obtains a decrease amount of the present BHQ with respect to the previous BHQ. The determination module 6 determines whether the decrease amount exceeds a threshold, and supplies a determination result to the suggestion unit 7. Due to this, the suggestion unit 7 can selectively make a suggestion in a case in which a suggestion should be made in accordance with the determination result.

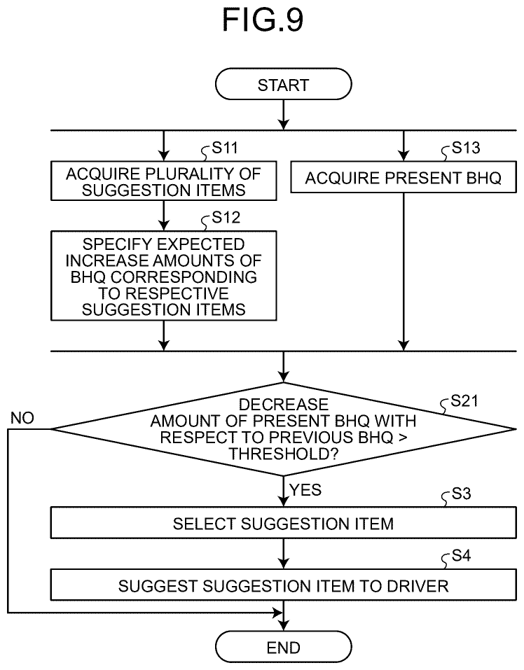

The assistance device 1 may perform operation as illustrated in FIG. 9. FIG. 9 is a flowchart illustrating the operation of the assistance device 1 according to a second modification of the embodiment.

The assistance device 1 performs the processing at S11 to S12 and the processing at S13 in parallel similarly to the first modification of the embodiment.

When the processing at S11 to S12 and the processing at S13 are both completed, the assistance device 1 subtracts the BHQ of the driver acquired at S13 from the BHQ of the driver previously acquired at S13, obtains the decrease amount of the BHQ, and determines whether the decrease amount of the BHQ exceeds the threshold (S21). If the decrease amount of the BHQ exceeds the threshold (Yes at S21), the assistance device 1 determines that a suggestion should be made, and performs the processing at S3 and S4 in FIG. 7 similarly to the embodiment. If the decrease amount of the BHQ does not exceed the threshold (No at S21), the assistance device 1 determines that a suggestion is not required, skips S3 and S4, and ends the processing.

With such an operation, the assistance device 1 can assist driving of the vehicle by the driver regarding spiritual wealth.

Alternatively, the assistance device 1 may correct the expected increase amount while considering a feature of the driver.

The assistance device 1 illustrated in FIG. 3 may further include the correction module 4. The acquisition module 2 acquires feature information. The feature information may include an interest of the driver and/or a taste of the driver. The correction module 4 receives the expected increase amounts of the suggestion items from the specification module 3, and receives the feature information from the acquisition module 2. The correction module 4 corrects the expected increase amounts of the suggestion items in accordance with the feature information. The correction module 4 supplies the corrected expected increase amounts to the selection module 5. Due to this, the selection module 5 can select one or more suggestion items from among the suggestion items in accordance with the expected increase amounts that are corrected while considering the feature of the driver.

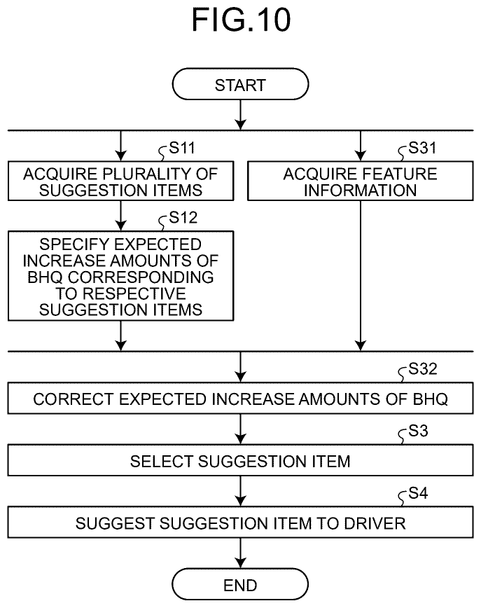

The assistance device 1 may perform operation as illustrated in FIG. 10. FIG. 10 is a flowchart illustrating the operation of the assistance device 1 according to a third modification of the embodiment.

The assistance device 1 performs the processing at S11 to S12 and the processing at S31 in parallel.

In the processing at S11 to S12, the same processing as that in the first modification of the embodiment is performed.

In processing at S31, the assistance device 1 acquires the feature information. The feature information may include an interest of the driver and/or a taste of the driver.

When the processing at S11 to S12 and the processing at S31 are both completed, the assistance device 1 corrects the expected increase amounts specified at S12 in accordance with the feature information acquired at S31 (S32). For example, the expected increase amounts included in the object information 9 illustrated in FIG. 4 and the expected increase amounts included in the characteristic information 10 illustrated in FIGS. 5A, 5B, and 5C are experimentally acquired in advance for the standard BHQ. The assistance device 1 may hold variation amount information indicating a variation amount of the BHQ that is statistically obtained in advance in accordance with an interest and/or a taste. The variation amount information may be stored in the non-volatile storage unit 18 in advance. The assistance device 1 may obtain the variation amount of the BHQ corresponding to an interest of the driver and/or a taste of the driver in accordance with the variation amount information and the feature information, and correct the expected increase amounts specified at S12 in accordance with the obtained variation amount. The assistance device 1 may correct the expected increase amounts specified at S12 by adding the variation amount to the expected increase amount.

Thereafter, the processing at S3 and S4 in FIG. 7 is performed similarly to the embodiment.

With such an operation, the assistance device 1 can assist driving of the vehicle by the driver regarding spiritual wealth.

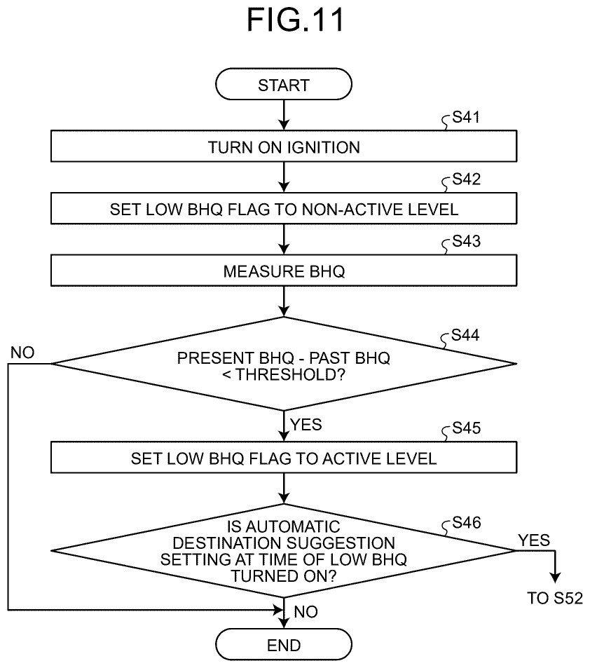

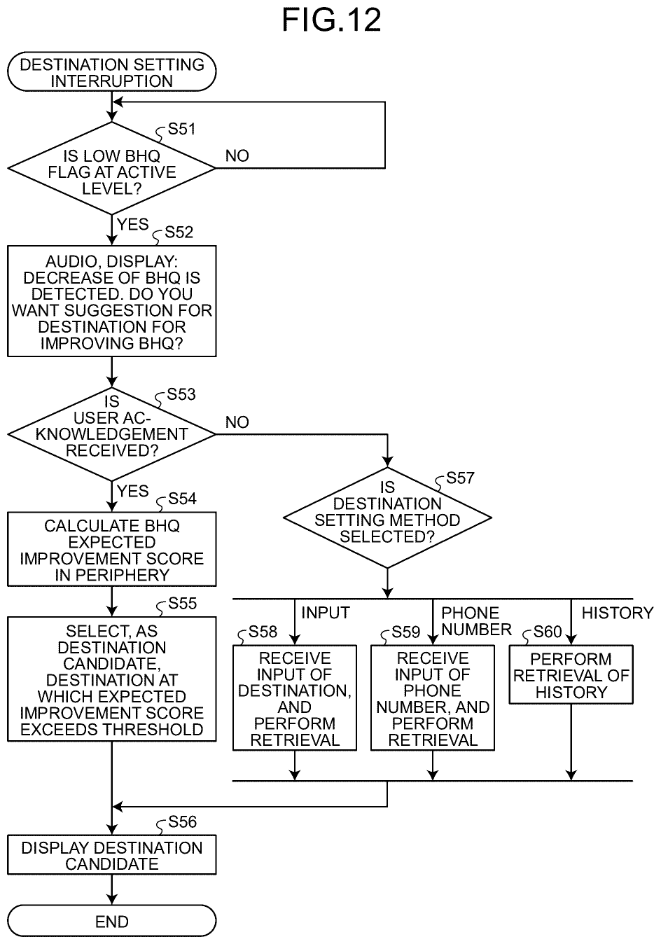

Alternatively, as illustrated in FIG. 11 and FIG. 12, the assistance device 1 may be implemented to perform control using a low BHQ flag. FIG. 11 and FIG. 12 are flowcharts each illustrating the operation of the assistance device 1 according to a fourth modification of the embodiment.

When the ignition of the vehicle 100 is turned on (S41), the assistance device 1 sets the low BHQ flag to a non-active level (S42), measures the BHQ of the driver (S43), and acquires the present BHQ of the driver. The assistance device 1 subtracts the BHQ in the past from the present BHQ, and if a subtraction result is not smaller than a threshold (No at S44), the processing ends.

If the subtraction result is smaller than the threshold (Yes at S44), the assistance device 1 sets the low BHQ flag to an active level (S45). If automatic destination suggestion setting at the time of low BHQ is not turned on (No at S46), the assistance device 1 ends the processing.

On the other hand, when receiving a request for destination setting interruption, the assistance device 1 stands by until the low BHQ flag becomes at the active level (No at S51). When the automatic destination suggestion setting at the time of low BHQ is turned on (Yes at S46), or the low BHQ flag becomes at the active level (Yes at S51), the assistance device 1 presents inquiry information of “Decrease of BHQ is detected. Do you want suggestion for destination for improving BHQ?” to the driver by the display unit 15 and/or the audio output unit 16 (S52).

When receiving a user acknowledgement within a predetermined time (Yes at S53), the assistance device 1 determines that assistance for improving the BHQ is required, and calculates a BHQ expected improvement score in the periphery (S54). The user acknowledgement may be an acknowledgement by pressing a button, an acknowledgement by audio input, or an acknowledgement by gesture. The BHQ expected improvement score is a score of the expected increase amount of the BHQ the maximum value of which is 100. The assistance device 1 selects, as a destination candidate, a destination at which the BHQ expected improvement score exceeds a threshold (S55), and displays the destination candidate on the display 104 and the like (S56).

In a case in which the user acknowledgement is not received within the predetermined time, or a case in which a user negative acknowledgement is received within the predetermined time (No at S53), the assistance device 1 determines that assistance for improving the BHQ is not required, ends the processing of itself, and entrusts the processing to the other devices in the vehicle 100. The other devices include a driving assistance device and a cabin space control device. For example, the driving assistance device displays, on the display 104 and the like, information for prompting the driver to select a destination setting method.

If “input” is selected as the destination setting method (“input” at S57), the driving assistance device receives an input of a destination through the input unit 13 to perform retrieval (S58), and displays, on the display 104 and the like, a retrieved destination as a destination candidate (S56).

If “phone number” is selected as the destination setting method (“phone number” at S57), the driving assistance device receives an input of a phone number through the input unit 13 to perform retrieval (S59), and displays, on the display 104 and the like, a retrieved destination as a destination candidate (S56).

If “history” is selected as the destination setting method, (“history” at S57), the driving assistance device performs retrieval of a history of destinations in the past (S60), and displays, on the display 104 and the like, a retrieved destination as a destination candidate (S56).

With such an operation, the assistance device 1 can maintain/improve the state of brain health by driving.

With the assistance device, the assistance method, and the computer program product according to the present disclosure, the state of brain health can be maintained/improved by driving.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An assistance device comprising:
a memory in which a program is stored; and
a processor coupled to the memory and configured to perform processing by executing the program, the processing including:
specifying expected increase amounts of a Brain Healthcare Quotient (BHQ) of a driver of a vehicle for a plurality of suggestion items;
selecting one or more suggestion items from among the plurality of suggestion items in accordance with the specified expected increase amounts; and
suggesting the one or more suggestion items to the driver.

2. The assistance device according to claim 1, wherein each of the suggestion items includes an object related to content to be suggested to the driver.

3. The assistance device according to claim 1, wherein each of the suggestion items includes a characteristic related to an additional element of content to be suggested to the driver.

4. The assistance device according to claim 2, wherein the object includes at least one of a destination, a path, a driving assistance function, a driving manner, and cabin space control.

5. The assistance device according to claim 3, wherein the characteristic includes at least one of novelty, enjoyment, and momentum.

6. The assistance device according to claim 1, wherein
the processing further includes:
acquiring a present BHQ of the driver; and
correcting the specified expected increase amounts in accordance with the present BHQ.

7. The assistance device according to claim 1, wherein
the processing further includes:
acquiring a present BHQ of the driver; and
suggesting the one or more suggestion items to the driver when a decrease amount of the present BHQ with respect to a previous BHQ exceeds a threshold.

8. The assistance device according to claim 1, wherein
the processing further includes:
acquiring feature information related to a feature of the driver; and
correcting the specified expected increase amounts in accordance with the acquired feature information.

9. The assistance device according to claim 1, wherein the processing further includes suggesting, to the driver, the one or more suggestion items together with a BHQ that is expected in accordance with the specified expected increase amounts.

10. An assistance method comprising:
specifying expected increase amounts of a Brain Healthcare Quotient (BHQ) of a driver of a vehicle for a plurality of suggestion items;
selecting one or more suggestion items from among the plurality of suggestion items in accordance with the specified expected increase amounts; and
suggesting the one or more suggestion items to the driver.

11. The assistance method according to claim 10, wherein each of the suggestion items includes an object related to content to be suggested to the driver.

12. The assistance method according to claim 10, wherein each of the suggestion items includes a characteristic related to an additional element of content to be suggested to the driver.

13. The assistance method according to claim 11, wherein the object includes at least one of a destination, a path, a driving assistance function, a driving manner, and cabin space control.

14. The assistance method according to claim 12, wherein the characteristic includes at least one of novelty, enjoyment, and momentum.

15. The assistance method according to claim 10, further comprising:
acquiring a present BHQ of the driver; and
correcting the specified expected increase amounts in accordance with the present BHQ.

16. The assistance method according to claim 10, further comprising:
acquiring a present BHQ of the driver, and
suggesting the one or more suggestion items to the driver when a decrease amount of the present BHQ with respect to a previous BHQ exceeds a threshold.

17. The assistance method according to claim 10, further comprising:
acquiring feature information related to a feature of the driver; and
correcting the specified expected increase amounts in accordance with the acquired feature information.

18. The assistance method according to claim 10, wherein the suggesting comprises suggesting, to the driver, the one or more suggestion items together with a BHQ that is expected in accordance with the specified expected increase amounts.

19. A computer program product including programmed instructions embodied in and stored on a non-transitory computer readable medium, wherein the instructions, when executed by a computer, cause the computer to perform:
specifying expected increase amounts of a Brain Healthcare Quotient (BHQ) of a driver of a vehicle for a plurality of suggestion items;
selecting one or more suggestion items from among the plurality of suggestion items in accordance with the specified expected increase amounts; and
suggesting the one or more suggestion items to the driver.

20. The computer program product according to claim 19, wherein each of the suggestion items includes an object related to content to be suggested to the driver or a characteristic related to an additional element of content to be suggested to the driver.
